(19) United States
(12) Patent Application Publication
(10) Pub. No.: US 2007/0131888 A1
(43) Pub. Date: Jun. 14, 2007

(54) THROTTLE VALVE AND PISTON RING THEREOF

(76) Inventors: Chien-Hsing Lai, Kao-Hsiung Hsien (TW); Ying-Yi Chang, Chia-Yi Hsien (TW); Chao-Hsien Cheng, Tainan Hsien (TW); Wen-Chen Shi, Tainan Hsien (TW); Ji-Zhen Huang, Tainan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/675,633

(22) Filed: Feb. 16, 2007

Related U.S. Application Data
(62) Division of application No. 10/905,468, filed on Jan. 5, 2005.

(51) Int. Cl. F16K 5/00

(52) U.S. Cl. 251/304

(57) ABSTRACT

A throttle valve connects with a chamber for adjusting air pressure in the chamber. The throttle valve has a housing having a channel in it, a piston ring positioned at an end of the channel, a stopper positioned in the channel, and a driver for rotating the stopper. The piston ring has a plane surface contacting with the housing, a first cambered surface contacting with the housing and vertically connecting with the plane surface, and a second cambered surface connecting with the first cambered surface. The second cambered surface of the piston ring contacts with a third cambered surface of the stopper.

### CROSS REFERENCE TO RELATED APPLICATIONS

This divisional application claims the benefit of co-pending U.S. application Ser. No. 10/905,468, filed on Jan. 05, 2005 and included herein by reference.

### BACKGROUND OF THE INVENTION

1. Field of the Invention

The present invention relates to a throttle valve and a piston ring of the throttle valve thereof, and more particularly, to a throttle valve for adjusting air pressure in a chemical vapor deposition (CVD) chamber and a piston ring of the throttle valve thereof.

2. Description of the Prior Art

A typical chemical vapor deposition (CVD) process is a thin film technique which deposits a thin film onto a wafer in a chemical manner. Currently, CVD processing has become one of the most essential thin film techniques in semiconductor fabrication. The performance of a throttle valve for controlling the air pressure in the CVD chamber is a main factor that influences the quantity of the CVD process. However, because the prior art throttle valve is not good enough, an issue of foreline powder back stream cannot be well controlled.

Please refer to FIG. 1, which is a diagram of a throttle valve 10 according to the prior art. The throttle valve 10 connects with a CVD chamber and a pump, where the pump is used to force gaseous reactants into the CVD chamber. The throttle valve 10 has a driver 12, a housing 14, a stopper 18, and a piston ring 20. A channel 16 connected between the pump and the CVD chamber is formed in the housing 14. The stopper 18 and the piston ring 20 ate positioned in the channel 16. Moreover, the piston ring 20 contacts with one side of the channel 16, which is adjacent to the pump. The driver 12 is used to rotate the stopper 18 to close or open the channel 16.

Please refer to FIGS. 1-3, where FIG. 2 is a top view of the piston ring 20 shown in FIG. 1, and FIG. 3 is a side view of the piston ring 20. The piston ring 20 has a bottom ring 22, two raised structures 22, a first cambered surface 24, a second cambered surface 28, and a fourth cambered surface 30. The two raised structures 22 stand on the bottom ring 22. The fourth cambered surface 30 vertically connects with the first cambered surface 24. The second cambered surface 28 and the fourth cambered surface 30 connect with the two raised structures 26. When the piston ring 20 is positioned in the channel 16, the first cambered surface 24 and a plane surface 23 of the bottom ring 22 contact with the housing 14 at one end of the channel 16. The stopper 18 has a third cambered surface 19, which has a radius approximates the radius of the second cambered surface 28. When the driver 12 rotates the stopper 18 to closes the channel 16, the second cambered surface 28 is completely touched by the third cambered surface 19. Moreover, a pathway 32 is formed in the piston ring 20, the gaseous reactants of the CVD process flows through the pathway 32 of the piston ring 20 into the housing 14 along a direction D. The direction indicates the direction from the pump to the CVD chamber.

However, when the piston ring 20 is installed in the channel 16, even the plane surface 23 and the first cambered surface 24 of the bottom ring 22 contact with the housing 14, the fourth cambered surface 30 does not contact with the housing 14, so the gaseous reactants easily escape from the chink between the first cambered surface 24 and the housing 14. Therefore, the performance of the throttle valve 10 to control the flow of the gaseous reactants and to adjust air pressure in the CVD chamber is not ideal. In addition, when the stopper 18 closes the pathway 32, the area that the housing 14 contacts with the piston ring 20 does not overlap the second cambered surface 28. As shown in FIG. 2, a ratio of the width B of the second cambered surface 28 to the width A of the piston ring 20 is between 0.2-0.3. Because the area that the second cambered surface 28 contacts with the stopper 18 is not greater enough, the gaseous reactants easily escape from the chink between the second cambered surface 28 and the stopper 18. Due to the structure of the piston ring 20, the flow of the gaseous reactants and the air pressure in the CVD chamber cannot be well controlled by the throttle valve 10.

### SUMMARY OF THE INVENTION

It is therefore a primary objective of the present invention to provide a new throttle valve and a piston ring of the throttle valve thereof to solve the above mentioned problems.

The throttle valve connects with a chamber for adjusting air pressure in the chamber. The throttle valve has a housing having a channel in it, a piston ring positioned at an end of the channel, a stopper positioned in the channel, and a driver for rotating the stopper. The piston ring has a plane surface contacting with the housing, a first cambered surface contacting with the housing and vertically connecting with the plane surface, and a second cambered surface connecting with the first cambered surface. The second cambered surface of the piston ring contacts with a third cambered surface of the stopper.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a throttle valve according to the prior art.

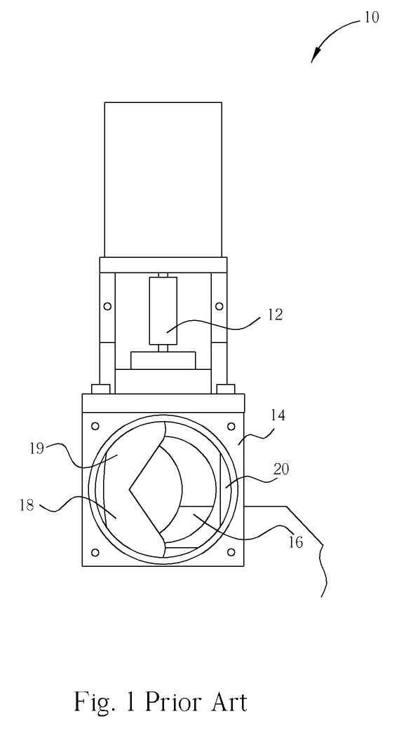

FIG. 2 is a top view of the piston ring shown in FIG. 1.

FIG. 3 is a side view of the piston ring shown in FIG. 1.

FIG. 4 is a diagram of a throttle valve according to the present invention.

FIG. 5 is a diagram of a piston ring shown in FIG. 4.

FIG. 6 is a top view of the piston ring shown in FIG. 5.

FIG. 7 is a side view of the piston ring shown in FIG. 5.

### DETAILED DESCRIPTION

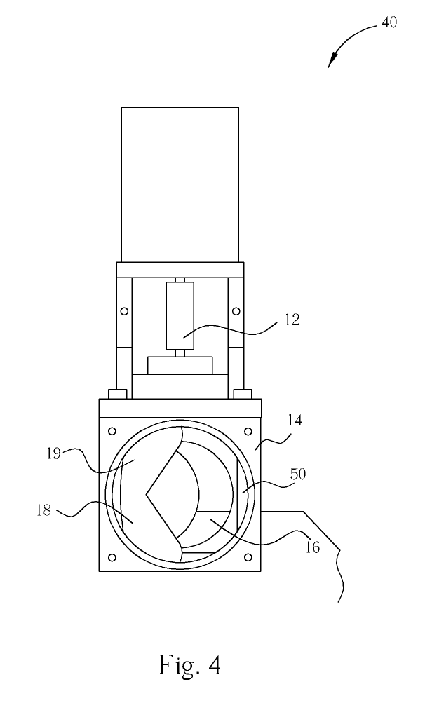

Please refer to FIG. 4, which is a diagram of a throttle valve 40 according to the present invention. The difference between the two throttle valves 10 and 40 is that the piston ring 20 of the throttle valve 10 is replaced by a piston ring 50 of the throttle valve 40. The throttle valve 40 also connects with a CVD chamber and a pump, where the pump is used to force gaseous reactants into the CVD chamber. The throttle valve 40 also has a driver 12, a housing 14, and a stopper 18. In the embodiment, the piston ring 50 is made of Teflon, and the stopper 18 is made of stainless steel. A channel 16 connected between the pump and the CVD chamber is formed in the housing 14. The stopper 18 and the piston ring 50 ate positioned in the channel 16. Moreover, the piston ring 50 contacts with one side of the channel 16, which is adjacent to the pump. The driver 12 is used to rotate the stopper 18 to close or open the channel 16.

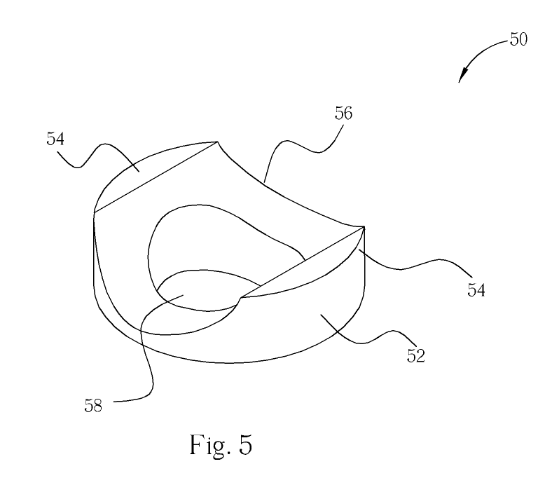

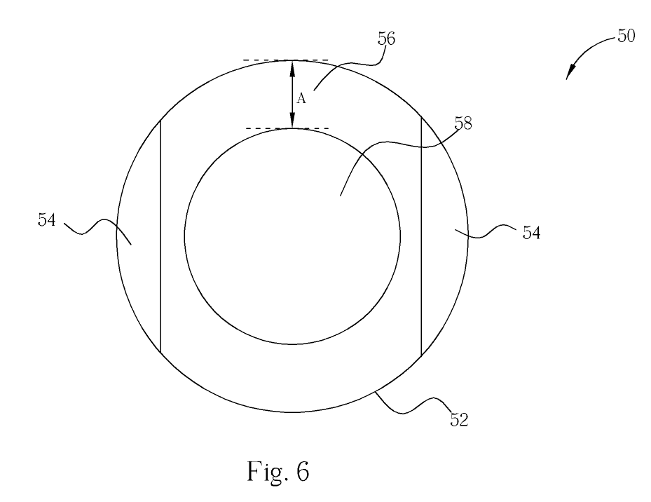

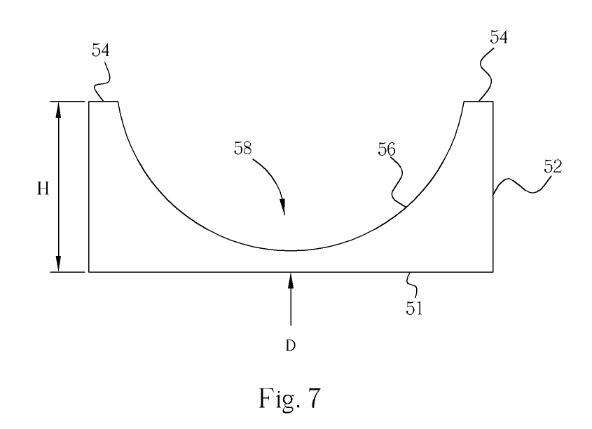

Please refer to FIGS. 5-7, where FIG. 5 is a diagram of the piston ring 50, FIG. 6 is a top view of the piston ring 50, and FIG. 7 is a side view of the piston ring 50. The piston ring 50 has a plane surface 51, a first cambered surface 52, a second cambered surface 56, and two raised structures 54. When the piston ring 50 is positioned in the channel 16, the plane surface 51 and the first cambered surface 52 contact with the housing 14 at one end of the channel 16. The second cambered surface 56 vertically connects with the first cambered surface 52. The first cambered surface 52 and the second cambered surface 56 connect with the two raised structures 54. In addition, a pathway 58 is formed in the piston ring 50, the gaseous reactants of the CVD process flows through the pathway 58 of the piston ring 50 into the housing 14 along a direction D. The direction indicates the direction from the pump to the CVD chamber. The stopper 18 has a third cambered surface 19, which has a radius approximates the radius of the second cambered surface 56. When the driver 12 rotates the stopper 18 to closes the pathway 58, the second cambered surface 56 is completely touched by the third cambered surface 19.

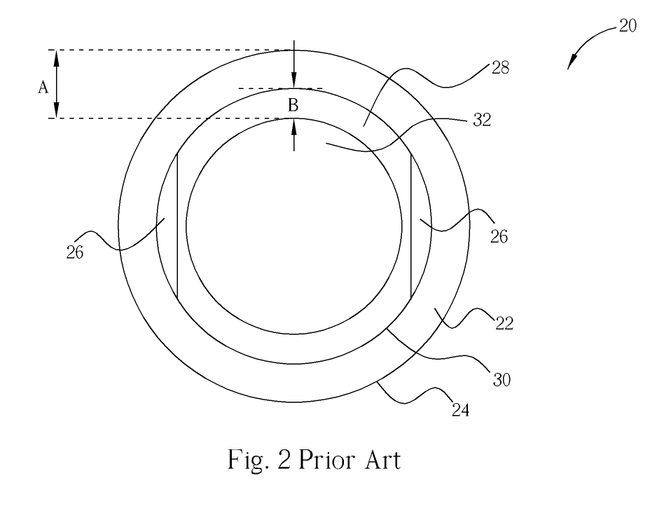

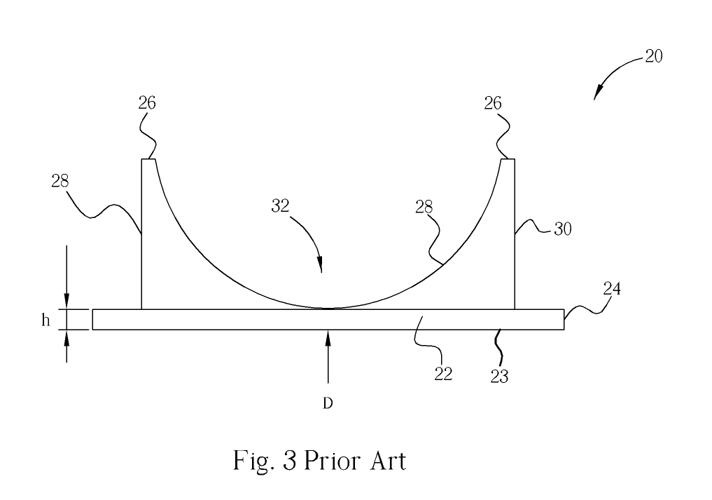

Please refer to FIG. 2 and FIG. 6, the width A of the piston ring 50 is the same as the width A of the piston ring 20. Therefore, when the stoppers 18 rotates at the same degree, the area that the stopper 18 contacts with the piston ring 50 is greater than the area that the stopper 18 contacts with the piston ring 20. The gaseous reactants, hence, hardly escape from the chink between the second cambered surface 56 and the stopper 18. Please refer to FIG. 3 and FIG. 7, the width H of the first cambered surface 52 of the piston ring 50 is greater than the width h of the first cambered surface 24 of the piston ring 20. Therefore, the area that the piston ring 50 contacts with the housing 14 is greater than the area that the piston ring 20 contacts with the housing 14. The gaseous reactants, hence, hardly escape from the chink between the second cambered surface 56 and the stopper 18. The gaseous reactants, hence, hardly escape from the chink between the first cambered surface 52 and the housing 14.

Compared with the prior art, the throttle valve and the piston ring of the throttle valve thereof according to the present invention are well designed. The first cambered surface and the second cambered surface properly contact with the housing and the stopper respectively. Therefore, the performance of the throttle valve to control the flow of the gaseous reactants and to adjust air pressure in the CVD chamber is ideal.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A throttle valve connected with a chamber for adjusting air pressure in the chamber, the throttle valve comprising:
a housing having a channel in it, and the channel being connected with the chamber;
a piston ring positioned at an end of the channel having:
a plane surface contacting with the housing;
a first cambered surface contacting with the housing and vertically connecting with the plane surface; and
a second cambered surface connecting with the first cambered surface;
a stopper positioned in the channel having a third cambered surface, the third cambered surface contacting with the second cambered surface; and
a driver for rotating the stopper.

2. The throttle valve of claim 1 wherein the piston ring further comprises two raised structures, the first cambered surface and the second cambered surface connect with the two raised structures.

3. The throttle valve of claim 1 wherein when the second cambered surface is completely touched by the third cambered surface, the channel is closed.

4. The throttle valve of claim 1 wherein the chamber is a chemical vapor deposition (CVD) chamber.

5. The throttle valve of claim 1 wherein the piston ring is made of Teflon.

6. The throttle valve of claim 1 wherein the stopper is made of stainless steel.
